(19) United States
(12) Patent Application Publication
(10) Pub. No.: US 2005/0274365 A1
(43) Pub. Date: Dec. 15, 2005

(54) Liquid saturation device

(76) Inventors: Edward Kahler, Colfax, WI (US); Antonio Ramirez, South Jesup, GA (US)

Correspondence Address: Edward Kahler, 222 Mountain View RD., McCaysville, GA, 30555, US

(21) Appl. No.: 10/866,629

(22) Filed: Jun. 14, 2004

(51) Int. Cl. F02M 23/00

(52) U.S. Cl. 123/533

(57) ABSTRACT

A device 10, and a method of saturating liquid fuel with air or oxygen for injecting into an internal combustion engine. The device 10, includes a fuel saturation chamber 18, connected to the engine fuel pump for receiving liquid fuel and connected to an air check valve 24, for directing air into the fuel saturation chamber 18. Then the saturated and diffused liquid fuel is fed into a combustion engine by saturated fuel outlet passage 15. The fuel saturation chamber 18, includes a particularly shaped diffusing plug 16, which diffuses air to saturate the liquid fuel by sufficient crossing grooves 21. This air diffusing and fuel saturating system and all of the working parts in the saturation chamber, perform by the very fuel pump pressure and timing. Obviously, the device's fitting could be made to fit at the desired engine manufacturer's configurations.

### BACKGROUND

1. Field of Invention

This invention is relative to fuel injected engines; specifically to such devices that are used to inject fuel into engine cylinders.

2. Description of Prior Art

Fuel injected engines commonly use a device called an injector which injects; fuel into an engine's fire chamber. However, such injectors could be improved in order to enhance and increase the engine's performance.

Inventors therefore created various types of injectors specifically to increase the flow of air or pure oxygen driven into the combustion chamber.

U.S. Pat. No. 5,241,938, displays a fuel injector having a plurality of cylindrical air passages which allow air to be introduced (by suction) into a saturation chamber which is open to the engine intake manifold, in a direction which causes air to intersect a supply of fuel from a fuel injector, for atomizing in the saturation chamber.

U.S. Pat. No. 5,884,611, displays an effervescent fuel injector suitable for diesel and direct injection engines applications. Particularly it is the object to provide an effervescent fuel injector which is capable of injecting, particularly intermittently, an atomized fuel spray with drops which range from 5 to 6 microns in size, without requiring high pressures. Thus the invention of these effervescent fuel injectors which contain many moving parts, and which increase the size of the injector (to meet the required fuel volume) and all of the foregoing increases the manufacturing cost, and necessitates not only the reconfiguration of existing engine design, but higher maintenance costs; all this making the effervescent injector non-cost effective.

Obviously, then, a need exists for a small, in-line, Liquid Saturation Device (LSD) which is upstream from the injectors, but downstream from the fuel pump. This system which can effectively obtain the desired degree of atomization at existing fuel pressures (to reduce manufacturing costs but still meeting emission standards) is a beneficial and cost-effective device.

A type of atomizer which demonstrably obtains significant improvement in liquid atomization relative to air assist atomizers at low pressures is the Liquid Saturating Device.

This Liquid Saturation Device requires no add-on driving mechanism to operate, and will b-e a low-cost item to manufacture due to its minimal size and few moving parts. It will be easily installed, with minimum maintenance, on manufacturer's existing engine configurations.

### SUMMARY

Therefore, referring to the foregoing, the presented invention has the primary object of providing a Liquid Saturation Device suitable for both diesel and gasoline engines.

This, and other objects of the this invention, are achieved by a preferred embodiment Liquid Saturation Device comprising:

A capsule having two inlet passages, one for receiving a pressurized fuel pulse, and;

The second for receiving a pressurized gas pulse. The whole including a saturation chamber, a diffusing plug, a metering shaft, a check valve and one outlet passage.

Pressurized gas is diffused into pressurized fuel by the diffusing plug design in the saturation chamber, upstream of both pressurized fuel and pressurized gas inlets, creating a saturation with gas fuel pulse for directing to the engine injectors via the outlet passage. All the moving parts in the saturation chamber are activated by the very fuel pump timing pulse.

### DRAWING FIGURES

Fig. one (1) depicts a particularly shaped capsule with two inlet passages, one outlet passage and a seal plate on top.

Fig. two (2), depicts a particularly shaped capsule with two inlet passages, a machined saturation chamber, a machined diffusing plug, a seal washer, a seal plate, a particular metering shaft, two springs, a spring retainer washer and a check ball.

Fig. three (3), depicts a sectional view of the saturation chamber.

### REFERENCE NUMBERS IN DIAGRAMS

10—Capsule
12—Liquid Saturation Device
13—Fuel inlet passage
14—Gas inlet passage
15—Saturated fuel outlet passage
16—Diffusing plug
17—Metering rod channel
18—Saturation chamber
19—Fuel receiving slot
19a—Air receiving slot
21—Plug saturating grooves
22—Metering rod
24—Check valve
25—Spring
26—Spring retainer
27—Spring retainer washer groove
28—Spring
29—Check valve ball
30—Seal cap
31—Seal ring
32—Thread
33—Fuel supply
34—Gas supply
35—Fuel flow
36—Gas
37—Saturated gas flow

### DETAILED DESCRIPTION OF THE PREFERRED EMBODIMENT

The present invention is a method and a device for saturating and diffusing air, oxygen or the like with a liquid fuel for an internal combustion engine.

Saturate and saturation are used herein to mean the process of saturating a liquid with a gas by charging or impregnating gas, such as air or oxygen into liquid fuel.

Diffusing and diffusion are used herein to meal the dissemination of the air or oxygen within a liquid fuel.

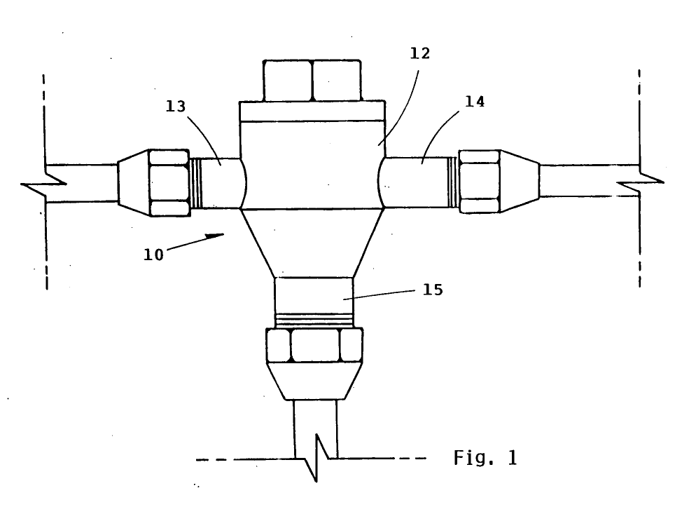

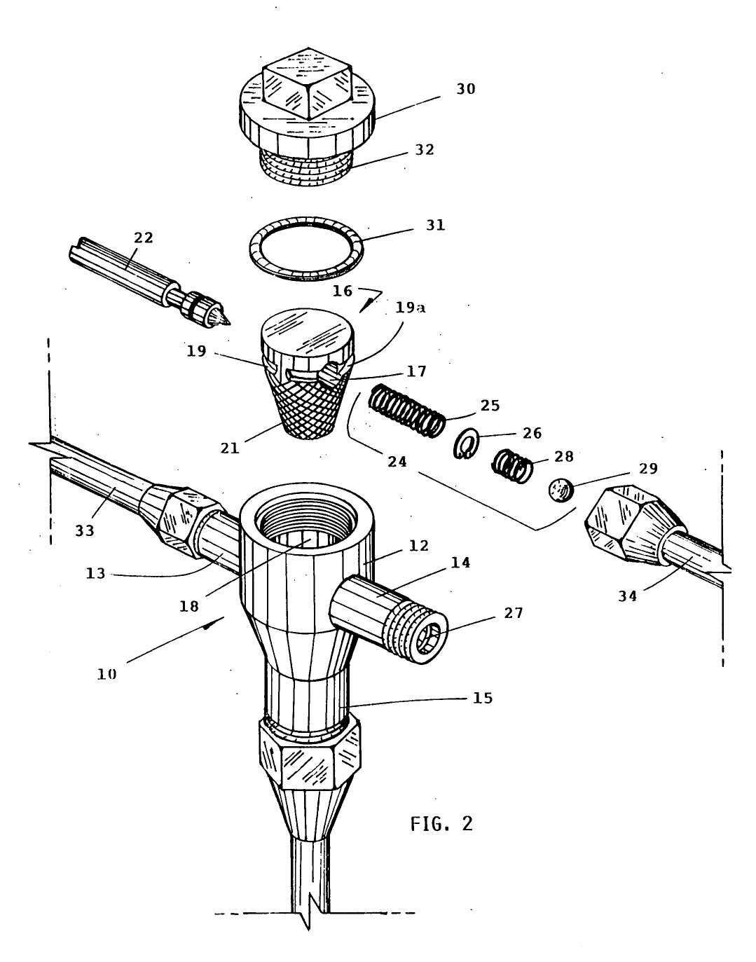

With reference to FIGS. 1 and 2: the preferred embodiment is a particularly shaped capsule leveled as a whole by numeral 10, having a generally cylindrical shape which includes two inlet passages 13 and 14, and one outlet passage 15, attached to said capsule 12, which is suitable to fit on any existing fuel injected engine.

FIG. 2 illustrates the preferred embodiment which includes a built-in fuel saturation chamber, 18, a diffusing plug 16, which includes a metering rod channel 17, a fuel receiving slot 19, an air receiving slot 19a, and sufficient saturating grooves 21, all of them crossing around the plug's conic section.

The diffusing plug 16, setting in the fuel saturation chamber 18. A particular metering rod 22, which sets through in both fuel and gas inlet passages 13 and 14, via the metering rod channel 17. Spring prove 25, spring retainer washer 26, spring 28, and spring retainer washer groove 27, a ball 29, which comprise a one-way check valve 24, are set through the gas inlet passage 14. A seal cap 30, and a seal ring 31, fit on top of the saturation chamber 18.

Operation

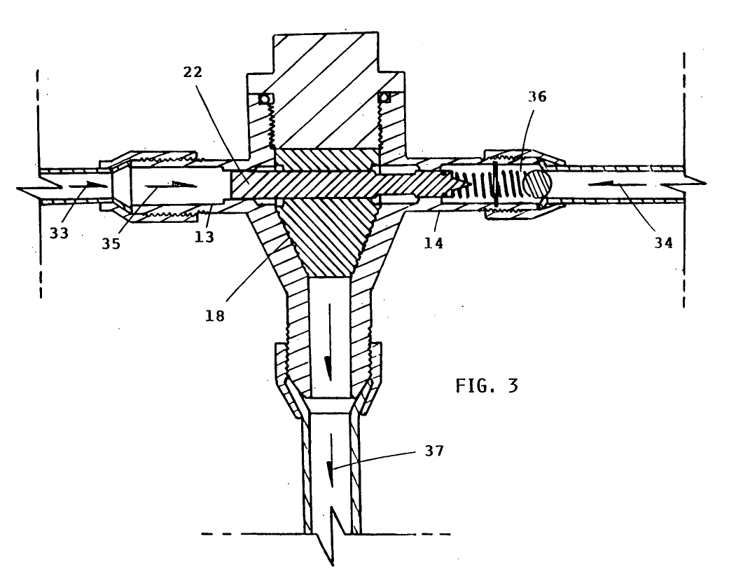

FIGS. 2 and 3 depict in simplified form the basic concept of the present invention, a Liquid Saturating Device (LSD) 12, as to a fuel pulsed flow.

A fuel supply 33, is connected at the fuel inlet passage 13, and a supply of pressurized gas 34, such as air or oxygen is connected at the gas inlet passage 14. The metering rod 22, which extends through both fuel and gas inlet passages 13 and 14, via the metering rod channel 27, perform by the engine fuel pump timing pressure, creating a pulsed fuel flow 35, at existing fuel pressure. Simultaneously, the check valve 24, performing or acting by the very fuel pump timing, releases a metered amount of gas 36, which depends on the required amount of fuel to be saturated. Both fuel and gas flowing simultaneously to the saturation chamber 18, via the plug fuel receiving slot 19, and via the plug gas receiving slot 19a, respectively, creating a mixing action or aeration throughout the integral design of the saturating chamber 18, and the diffusing plug 16, where the pressurized fuel flow 35, clash with the flowing gas 36, in the abundantly crossed plug saturating grooves 21. Then a saturated fuel flow 37, still going downstream to the engine injectors via the saturated fuel outlet passage 15.

The chamber steel plate 30, and chamber seal ring 31, are mounted on top of the duel saturation chamber 18, for assembly and disassembly.

The process of supply fuel and gas are variable and adjustable by using the existing fuel pump and the fine tuning used for each individual or particular engine is not sacrificed.

Accordingly, the present invention is not to be construed as limited to the forms shown, which are to be considered illustrative, not restrictive.

1. A diffusing assembly for saturating liquid fuel with air or other gas, for injecting into an internal combustion engine, comprising:
A. A generally cylindrical capsule 10, having a built-in fuel saturation chamber including a fuel inlet passage for receiving liquid fuel under pressure into said fuel saturation chamber for saturating said liquid fuel with a gas; an outlet passage for directing liquid fuel saturated and diffused with gas from said fuel saturation chamber into a combustion engine whereby liquid fuel, saturated and diffused with gas is used to feed a combustion engine.

2. A device in accordance with claim one (1), where said fuel saturation chamber having a diffusing plug therein, which includes a shaft guide cavity in line with fuel and gas inlet passages, wherein a metering shaft is setting via said fuel inlet passage for being activated in parallel with the fuel pump timing and with existing fuel pressure, creating a pulsed fuel flow from said fuel inlet passage for being diffused with gas in said saturation chamber.

3. A device in accordance with claim two (2), wherein said diffusing plug includes a fuel receiving slot which is adjoined to the fuel inlet passage for receiving a pulse of pressurized liquid fuel for being saturated with gas in the saturation chamber.

4. A device in accordance with claim two (2), wherein said diffusing plug includes a gas receiving slot which is adjoined to the gas inlet passage for receiving a pulse of pressurized gas for directing and diffusing with the pressurized liquid fuel pulse in said saturation chamber.

5. A device in accordance with claim two (2), wherein said diffusing plug includes a built-in, all around conic section of said diffusing plug, sufficient crossing grooves, one-half of which being connected to the liquid fuel receiving slot, the other half being connected to the pressured yens receiving slot for directing pressurized liquid fuel pulse four being saturated with pressurized gas wherein said liquid fuel clashing with pressurized gas at each of sufficient crossing grooves, up stream in said saturation chamber.

6. A device in accordance with claim one (1) wherein, said fuel saturation chamber includes a gas inlet passage having two (2) springs, a spring retainer washer between said two springs and a ball wherein said two spring, retainer washer and ball along with the metering shaft acting as a check valve for directing pressurized gas into said saturation chamber via the gas inlet passage.

7. A device in accordance with claim six (6) wherein said check valve being operated by the pulsed acting of the metering shaft creating a pulsed gas flow for dissecting and diffusing with the pressurized liquid fuel in the saturation chamber.

8. A device in accordance with claim two (2) wherein said fuel saturation chamber includes a outlet passage for directing liquid fuel saturated and diffused with gas wherefrom said fuel saturation chamber to feed a combustion engine which requires no add-on driving mechanism to operate.

9. A device in accordance with claim one (1) wherein said device, a small in-line (LSD) system up stream from the injectors but after the fuel pump, which can obtain tire desired degree of atomization at existing fuel pressure with manufacturing cost greatly reduced while still meeting emissions requirements.

10. A device in accordance with claim one (1) wherein said device a type of atomizer which is designed to obtain significant improvement in liquid atomization relative to air assist atomizers at low pressure whereas a gas such as, but not restricted to, air-oxygen is injected into the flowing liquid upstream of fuel before the existing injectors, but after the fuel pump of which is the timing and drive of said (LSD) which requires no add-on driving mechanism to operate.

11. A device in accordance with claim one (1) wherein said device will be low cost to manufacture due to the physical size and minimal moving parts and will be very easily installed and maintained on existing engine manufacturer's configurations to obtain significant improvement as to performance and efficiency; fuel savings and significant reduction of pollution emissions.
